(19) United States
(12) Patent Application Publication
(10) Pub. No.: US 2015/0163841 A1
(43) Pub. Date: Jun. 11, 2015

(54) METHOD FOR PROCESSING INFORMATION AND ELECTRONIC APPARATUS

(71) Applicants: Lenovo (Beijing) Co., Ltd., Beijing (CN); Beijing Lenovo Software Ltd., Beijing (CN)

(72) Inventors: Lei Zhao, Beijing (CN); Yu Chen, Beijing (CN); Hui Wang, Beijing (CN); Shaowei Chen, Beijing (CN)

(73) Assignees: Lenovo (Beijing) Co., Ltd., Beijing (CN); Beijing Lenovo Software Ltd., Beijing (CN)

(21) Appl. No.: 14/229,935

(22) Filed: Mar. 30, 2014

(30) Foreign Application Priority Data
Dec. 11, 2013 (CN) 201310676505.5
Dec. 11, 2013 (CN) 201310677076.3

(51) Int. Cl. H04W 76/02; A63F 13/31; H04W 4/00; H04W 4/08; H04W 4/20

(52) U.S. Cl. CPC H04W 76/023; H04W 4/08; H04W 4/20; H04W 4/008; A63F 13/31

(57) ABSTRACT

A method for processing information includes: acquiring, in the case where a first application runs, a first controlling operation for the first application, wherein the first controlling operation instructs to establish a first group comprising at least two participants; controlling the first wireless communication module to serve as a wireless access node generating a radiation signal; receiving response information from a second electronic apparatus; establishing, in a radio link layer, a direct communication channel with the second electronic apparatus upon reception of the response information; and adding, through the direct communication channel, the second electronic apparatus to the first group.

### CROSS-REFERENCES TO RELATED APPLICATIONS

The present application claims the priority to Chinese Patent Application No. 201310676505.5, entitled “METHOD FOR PROCESSING INFORMATION AND ELECTRONIC APPARATUS”, filed with the Chinese State Intellectual Property Office on Dec. 11, 2013, and the priority to Chinese Patent Application No. 201310677076.3, entitled “METHOD FOR PROCESSING INFORMATION AND ELECTRONIC APPARATUS”, field with the Chinese State Intellectual Property Office on Dec. 11, 2013, which are incorporated herein by reference in their entireties.

### TECHNICAL FIELD

The disclosure relates to the field of electronic technology, and particularly to a method for processing information and an electronic apparatus.

### BACKGROUND

With the quick development of electronic technology, thus people's lives are tightly linked with network, and various electronic products with different functions. With the improvement of living standards, electronic products such as laptop computer, PAD, and smartphone have been widely popularized. Particularly, handheld mobile devices such as smartphone and tablet computer have been popularized fastest.

With the popularization of the mobile devices, devices such as smartphone and tablet computer continuously become entertainment devices kept with people, who may employ these mobile devices to establish an interconnection with other users in an application, so as to enjoy entertainment such as a game together.

However, in the case where a user is on a trip or takes part in an outdoor activity, a situation where no extranet is available may occur often. Currently, without an extranet, a connection established between an electronic apparatus and other electronic apparatus By Bluetooth, and then the users of the electronic apparatus enter the same game application to establish a group and play a game.

However, in the process of implementing the inventive technical solution in the embodiments of the disclosure, the inventor found that there exists at least the following technical problem in the technical solution mentioned above.

Firstly using a Bluetooth to establish a connection and then entering an application to establish a group and play a game is only limited to a situation that two electronic apparatuss in close proximity to each other join the group, in addition to that, the two electronic apparatuss can enter the application and join the same group only after establishing a communication connection.

In other words, in the existing technology, without an extranet, there exists a technical problem that an electronic apparatus can not automatically establish, after entering an application and establishing a group, a connection to an electronic apparatus that selects to join the group.

### SUMMARY

According to the embodiments of the disclosure, a method for processing information and an electronic apparatus are provided to solve a technical problem in the existing technology that an electronic apparatus can not automatically establish, after entering an application and establishing a group, a connection to an electronic apparatus that selects to join the group, without an extranet.

In an aspect, according to the embodiments of the disclosure, the following technical solutions are provided.

A method for processing information applied to a first electronic apparatus, the first electronic apparatus including a first wireless communication module and being able to obtain a first application, and in the case where the first electronic apparatus has the first application and the first wireless communication module is in an operating state, the method including:

acquiring, in the case where a first application runs, a first controlling operation for the first application, wherein the first controlling operation instructs to establish a first group comprising at least two participants;

controlling the first wireless communication module to serve as a wireless access node generating a radiation signal;

receiving response information from a second electronic apparatus, wherein the second electronic apparatus in a coverage area of the radiation signal, and the response information is generated by the second electronic apparatus in the case where the wireless access node is scanned by the second electronic apparatus;

establishing, in a radio link layer, a direct communication channel with the second electronic apparatus upon reception of the response information; and

adding, through the direct communication channel, the second electronic apparatus to the first group.

A method for processing information applied to a second electronic apparatus, the second electronic apparatus comprises a second wireless communication module, in the case where the second wireless communication module is in an operating state, the method includes:

acquiring, in the case where a first application runs, a second controlling operation for the first application, wherein the second controlling operation instructs to scan at least one wireless access node;

controlling the second wireless communication module to receive at least one radiation signal from the at least one wireless access node;

displaying the at least one wireless access node;

selecting a first wireless access node from the at least one wireless access node, generating and sending response information to the first wireless access node, to facilitate a first electronic establishing a direct communication channel between the first electronic apparatus and the second electronic apparatus; and

joining a first group established by the first electronic apparatus through the direct communication channel.

Optionally, the displaying the at least one wireless access node includes:

displaying at least one of identifier corresponding to the at least one wireless access node by a display module.

Optionally, the method further includes:

starting a first general application corresponding to a first display identifier based on the first display identifier.

Optionally, selecting a first wireless access node from the at least one wireless access node includes:

acquiring M wireless access nodes by the second wireless communication module performing scan; and

selecting K first wireless access nodes confirming to a first preset condition from the M wireless access nodes, wherein M≧K.

Optionally, the first preset condition include:

a display identifier corresponding to the first wireless access node is a display identifier corresponding to a general application installed on the second electronic apparatus.

Optionally, in the case where the second electronic apparatus is connected with a server, the first preset condition includes:

a display identifier corresponding to the first wireless access node is a display identifier corresponding to a general application stored in the server.

Optionally, starting a starting a first general application corresponding to a first display identifier based on the first display identifier includes:

generating a first acquiring request, sending the first acquiring request and the first display identifier to the server;

receiving an installation file of the first general application returned by the server; and

installing and starting the first general application based on the installation file.

Optionally, in the case where the first general application is not installed on the second electronic apparatus, the starting the starting a starting a first general application corresponding to a first display identifier based on the first display identifier includes:

generating a second acquiring request, sending the second acquiring request and the first display identifier to the first wireless access node corresponding to the first display identifier;

receiving an installation file of the first general application returned by the first wireless access node; and

installing and starting the first general application based on the installation file.

An electronic apparatus, including a first wireless communication module, a first acquiring module, a first response module and a first establishing module; where

the first acquiring module is configured to acquire, in the case where a first application runs, a first controlling operation for the first application, wherein the first controlling operation instructs to establish a first group comprising at least two participants;

the first response module is configured to control the first wireless communication module to server as a wireless access node generating a radiation signal, receive response information from a second electronic apparatus, wherein the second electronic apparatus in a coverage area of the radiation signal, and the response information is generated by the second electronic apparatus in the case where the wireless access node is scanned by the second electronic apparatus; and

the first establishing module is configured to establish, in a radio link layer, a direct communication channel with the second electronic apparatus upon reception of the response information, add the second electronic apparatus to join the first group through the direct communication channel.

An electronic apparatus, including a second communication module, a second acquiring module, a second response module, a display module and a processing module, where

the second acquiring module is configured to acquire, in the case where a first application runs, a second controlling operation for the first application, wherein the second controlling operation instructs to scan at least one wireless access node;

the second response module is configured to control the second wireless communication module to receive at least one radiation signal from the at least one wireless access node;

the display module is configured to display the at least one wireless access node; and

the processing module is configured to select a first wireless access node from the at least one wireless access node, and join a first group established by the first wireless access node.

Optionally, the electronic apparatus displays at least one of identifier corresponding to the at least one wireless access node by the display module;

the second response module is further configured to start a general application corresponding to a first display identifier based on the first display identifier.

Optionally, the second response module includes:

a wireless communication module, configured to acquire M wireless access nodes by performing scan; and

a filtering unit, configured to select K first wireless access nodes confirming to a first preset condition from the M wireless access nodes, wherein M≧K.

Optionally, the filtering unit further configured to:

select K first wireless access nodes from the M wireless access nodes, based on M display identifier in one-to-one correspondence with the M wireless access nodes, wherein display identifiers corresponding to the K wireless access nodes are display identifiers corresponding to the general applications possessed by the electronic apparatus.

Optionally, in the case the electronic apparatus is connected with a server, the filtering unit is configured to:

select the K first wireless access nodes from the M wireless access nodes, based on the M display identifiers in one-to-one correspondence with the M wireless access nodes, wherein K display identifiers corresponding to the K first wireless access nodes are display identifier corresponding to the general applications stored in by server.

Optionally, the processing module includes:

a first sending unit, configured to a first acquiring request, send the first acquiring request and the first display identifier to the server;

a first receiving unit, configured to receive an installation file of the first general application return by the server; and

a starting unit, configured to install and start the first general application based on the installation file.

Optionally, in the case where the first general application corresponding to the first display identifier is not installed on the electronic apparatus, the processing module includes:

a second sending unit, configured to generate a second acquiring request, and send the second acquiring request and the first display identifier to the first wireless access node corresponding to the first display identifier;

a second receiving unit, configured to receive an installation file of the first general application returned by the first wireless access node; and

a second starting unit, configured to install and start the first general application based on the installation file.

With the technical solutions provided in the embodiments of the disclosure, have at least the following technical effects or advantages, the technical effect is achieved that an electronic apparatus can automatically establish, after entering an application and establishing a group, a connection to other electronic apparatus that selects to join the group without an extranet.

### BRIEF DESCRIPTION OF THE DRAWINGS

FIG. 1 is a flowchart illustrating a method for processing information according to a first embodiment of the disclosure;

FIG. 2 is a flowchart illustrating a method for processing information according to a second embodiment of the disclosure;

FIG. 3 is a flowchart illustrating a method for processing information according to a third embodiment of the disclosure;

FIG. 4 is a schematic diagram for displaying a display identification according to the third embodiment of the disclosure;

FIG. 5 is a flowchart illustrating a method for processing information according to a fourth embodiment of the disclosure;

FIG. 6 is a schematic structural diagram illustrating an electronic apparatus according to a fifth embodiment of the disclosure;

FIG. 7 is a schematic structural diagram illustrating an electronic apparatus according to a sixth embodiment of the disclosure; and

FIG. 8 is a schematic structural diagram illustrating an electronic apparatus according to a seventh embodiment of the disclosure.

### DETAILED DESCRIPTION

According to the embodiments of the disclosure, a method for processing information and an electronic apparatus are provided to achieve a technical effect that an electronic apparatus can automatically establish, after entering an application and establishing a group, a connection to an electronic apparatus that selects to join the group without an extranet.

In order to solve the technical problem in the above existing technology, in an aspect, a general idea of the technical solutions provided in the embodiments of the disclosure is as follows.

A method for processing information applied to a first electronic, the first electronic apparatus includes a first wireless communication module, in the case where the first wireless communication module is in an operating state, the method includes:

acquiring, in the case where a first application runs, a first controlling operation for the first application, wherein the first controlling operation instructs to establish a first group comprising at least two participants;

controlling the first wireless communication module to serve as a wireless access node generating a radiation signal;

receiving response information from a second electronic apparatus, where the second electronic apparatus in a coverage area of the radiation signal, and the response information is generated by the second electronic apparatus in the case where the wireless access node is scanned by the second electronic apparatus;

establishing, in a radio link layer, a direct communication channel with the second electronic apparatus upon reception of the response information; and

adding, through the direct communication channel, the second electronic apparatus to the first group.

It can be seen from the above description that, in the case where the first application runs, by establishing the first group, controlling the first wireless communication module to serve as a wireless access node to generate the radiation signal, such that the wireless access node is able to be scanned by the second electronic apparatus in the coverage area of the radiation signal, and by establishing, in the case where the second electronic apparatus selects to join the first group, a direct communication channel between the first electronic apparatus and the second electronic apparatus, a technical effect is achieved that an electronic apparatus can automatically establish, after entering an application and establishing a group, a connection to an electronic apparatus that selects to join the group without an extranet.

In order to better understand the above technical solutions, the above technical solutions will be explained in detail hereinafter in conjunction with the drawings and the detailed description.

### First Embodiment

In the first embodiment, there is provided a method for processing information applied to a first electronic apparatus that includes a first wireless communication module and is able to obtain a first application. The first electronic apparatus may be an electronic apparatus such as a smartphone, laptop, a tablet computer, or a desktop computer, which will not be enumerated fully in this embodiment.

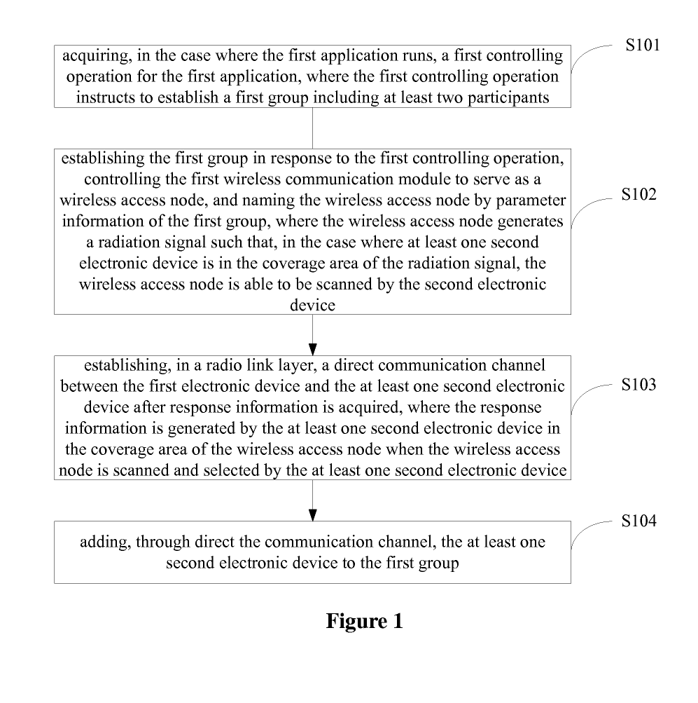

Referring to FIG. 1, which is a flowchart of a method for processing information according to the first embodiment of the disclosure. In the case where the first electronic apparatus has the first application and the first wireless communication module is in an operating state, the method includes step S101 to step S104.

In step S101, acquiring, in the case where the first application runs, a first controlling operation for the first application, where the first controlling operation instructs to establish a first group including at least two participants.

In step S102, establishing the first group in response to the first controlling operation, controlling the first wireless communication module to serve as a wireless access node, and naming the wireless access node by parameter information of the first group, where the wireless access node generates a radiation signal such that, in the case where at least one second electronic apparatus is in the coverage area of the radiation signal, the wireless access node is able to be scanned by the second electronic apparatus.

In step S103, establishing, in a radio link layer, a direct communication channel between the first electronic apparatus and the at least one second electronic apparatus after response information is acquired, where the response information is generated by the at least one second electronic apparatus in the coverage area of the wireless access node when the wireless access node is scanned and selected by the at least one second electronic apparatus.

In step S104, adding, through direct the communication channel, the at least one second electronic apparatus to the first group.

In a practical application, the second electronic apparatus may also be an electronic apparatus such as a smartphone, laptop, tablet computer, or desktop computer, which will not be enumerated fully in this embodiment.

At first, in the step S101, in the case where the first application runs, a first controlling operation for the first application is acquired, the first controlling operation instructs to establish a first group capable of including at least two participants.

In a specific implementation, the first controlling operation may be an operation for an interface on which the first application runs, such as a touch click operation, or a mouse click operation, and may also be a shake operation for the first electronic apparatus, or a preset gesture operation, which will not be enumerated fully in this embodiment.

Then, after acquiring the first controlling operation through the step S101, the method proceeds to the step S102, i.e. establishing the first group in response to the first controlling operation, controlling the first wireless communication module to serve as a wireless access node, and naming the wireless access node by parameter information of the first group, where the wireless access node generates a radiation signal such that, in the case where at least one second electronic apparatus is in the coverage area of the radiation signal, the wireless access node is able to be scanned by the at least one second electronic apparatus.

In the embodiments of the disclosure, the wireless access node may be a WIFI hotspot, and the wireless access node is set as a WIFI hotspot, which can meet that two or more electronic apparatuss simultaneously join a same group of a same application.

Hereinafter, a detailed explanation will be performed on how to generate, in the case where a communication connection is not established between the first electronic apparatus and the second electronic apparatus, the radiation signal such that the wireless access node is able to be scanned by the second electronic apparatus.

In the case where the first electronic apparatus is not in extranet coverage, the first wireless communication module of the electronic apparatus still has a function of sending and receiving signal due to its hardware structure. After controlling the first wireless communication module of the first electronic apparatus to turn on its function of sending and receiving signal, the first wireless communication module continuously generates and sends radiation signals. At this time, if the second electronic apparatus is in a coverage area of the radiation signal and a function of sending and receiving signal is also turned on for the second wireless communication module of the second electronic apparatus, then the radiation signal sent from the first wireless communication module can be received by the second wireless communication module in the case where a communication connection is not established between the first electronic apparatus and the second electronic apparatus, and the first electronic apparatus is thus scanned by the second wireless communication module.

Specifically, in the step S102, the wireless access node is named by parameter information of the first group, in the case where the first application of the at least one second electronic apparatus runs, the wireless access node named by the parameter information can be scanned by the at least one second electronic apparatus based on the parameter information of the first group in the first application, and thus the at least one second electronic apparatus may determine, through selecting to join the first group, to select the wireless access node named by parameter information of the first group.

After generating, through step S102, a radiation signal such that the wireless access node can be scanned and selected by the at least one second electronic apparatus, the method proceeds to step S103, i.e. establishing, in a radio link layer, a direct communication channel between the first electronic apparatus and the at least one second electronic apparatus after response information is acquired, where the response information is generated by the at least one second electronic apparatus in the coverage area of the wireless access node in the case where the wireless access node is scanned and selected by the at least one second electronic apparatus.

In a specific implementation, the response information is a connection request that the at least one second electronic apparatus sends to the first electronic apparatus after determining, through selecting to join the first group, to select the wireless access node named by parameter information of the first group. After the first electronic apparatus acquires the connection request, the first electronic apparatus establishes, based on the connection request, in a radio link layer, a direct communication channel to the at least one second electronic apparatus.

After establishing the communication channel through the step S103, the method proceeds to the step S104, i.e. adding, through the communication channel, the at least one second electronic apparatus to the first group.

In the embodiments of the disclosure, after the adding, through the communication channel, the at least one second electronic apparatus to the first group, the method further includes:

in the case where the first application stops running, breaking the communication channel and controlling the first wireless communication module to stop serving as the wireless access node.

Specifically, in the case where the first application stops running, by breaking the communication channel and controlling the first wireless communication module to stop serving as the wireless access node, it can be avoided that other electronic apparatuss acquire information stored on the first electronic apparatus through the communication channel, thus achieving a technical effect of improving safety for the information stored on the first electronic apparatus.

Hereinafter, viewed from a perspective of human-computer interaction, an explanation is carried out by taking that the first electronic apparatus is a smartphone and the first application is a board game installed on the smartphone as an example.

For example, user A is in travel, and in the case where he is on the train, he wants to play a board game with other smartphone users through network, but user A does not know which users Around him also want to play the same board game, thus the user A turns on an application of the board game on the smartphone and performs a touch click on a displaying interface of the application to select “no extranet mode”, then two options of “join a group” and “establish a new group” are displayed on the displaying interface of the application.

After the user A performs a touch click on the option of “establish a new group”, the smartphone establishes a first group in response to an selection operation, controls a wireless communication module in the smartphone to be a wireless access node and to turn on its function of sending and receiving signal so as to generate and send radiation signals, and names the wireless access node “First Board”.

In the case where user B also wants to play a board game, user B turns on an application of the board game on his tablet computer and performs a touch click on a displaying interface of the application to select “no extranet mode”, then selects an option of “join a group” from two options of “join a group” and “establish a new group”. At this time, the wireless access node established by user A, which is displayed on the board application interface of the tablet computer as a group named “First Board”, is scanned through a wireless communication module on the tablet computer of user B.

User B sends, after touching to select the group named “First Board”, a connection request to the smartphone of user A.

The smartphone of user A establishes, after receiving the connection request, in a radio link layer, a direct communication channel to the tablet computer of user B. Through the direct communication channel, the tablet computer of user B joins the first group named “First Board”.

User A and user B play the board game in the first group through network.

In another aspect, based on the same inventive concept, according to another embodiment of the disclosure, it is provided a method for processing information applied in the at least one second electronic apparatus of the first embodiment, which is explained in detail in second embodiment.

Another method for processing information applied to a second electronic apparatus, the second electronic apparatus includes a second wireless communication module, in the case where the second wireless communication module is in an operating state, the method includes:

acquiring, in the case where a first application runs, a second controlling operation for the first application, wherein the second controlling operation instructs to scan at least one wireless access node;

controlling the second wireless communication module to receive at least one radiation signal from the at least one wireless access node;

displaying the at least one wireless access node;

selecting a first wireless access node from the at least one wireless access node, generating and sending response information to the first wireless access node, to facilitate a first electronic establishing a direct communication channel between the first electronic apparatus and the second electronic apparatus; and

joining a first group established by the first electronic apparatus through the direct communication channel.

### Second Embodiment

In the second embodiment, there is provided a method for processing information applied to a second electronic apparatus that includes a second wireless communication module and is able to obtain a first application. The second electronic apparatus may be an electronic apparatus such as a smartphone, laptop, a tablet computer, or a desktop computer, which will not be enumerated fully in this embodiment.

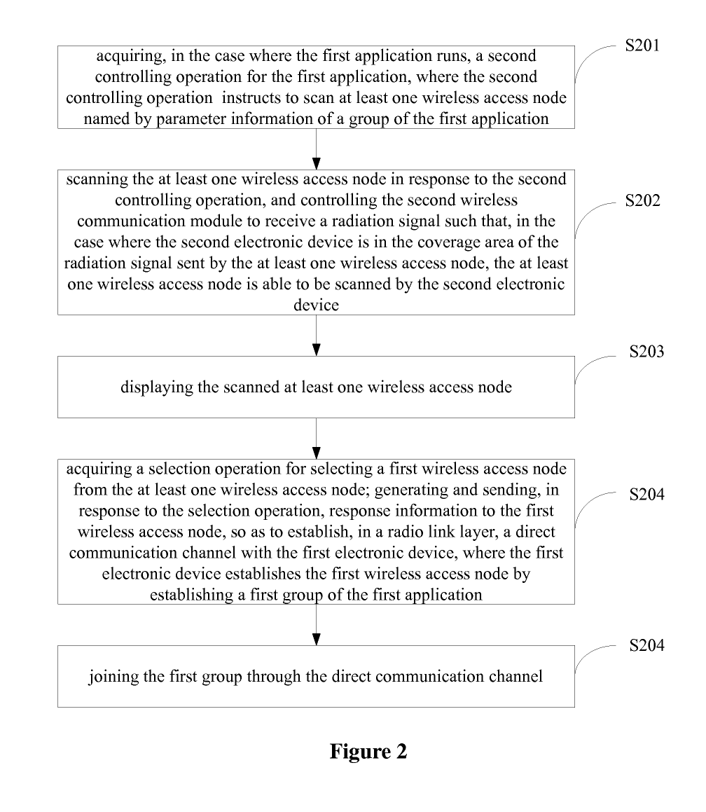

Referring to FIG. 2, which is a flowchart of a method for processing information according to the second embodiment of the disclosure. In the case where the second electronic apparatus has the first application and the second wireless communication module is in an operating state, the method includes step S201 to step S205.

In step S201, acquiring, in the case where the first application runs, a second controlling operation for the first application, where the second controlling operation instructs to scan at least one wireless access node named by parameter information of a group of the first application.

In step S202, scanning the at least one wireless access node in response to the second controlling operation, and controlling the second wireless communication module to receive a radiation signal such that, in the case where the second electronic apparatus is in the coverage area of the radiation signal sent by the at least one wireless access node, the at least one wireless access node is able to be scanned by the second electronic apparatus.

In step S203, displaying the scanned at least one wireless access node.

In step S204, acquiring a selection operation for selecting a first wireless access node from the at least one wireless access node; generating and sending, in response to the selection operation, response information to the first wireless access node, so as to establish, in a radio link layer, a direct communication channel with the first electronic apparatus, where the first electronic apparatus establishes the first wireless access node by establishing a first group of the first application.

In step S205, joining the first group through the direct communication channel.

A detailed explanation has been performed on how the at least one wireless access node named by parameter information of a group of the first application is scanned by the second electronic apparatus in the case where a communication connection is not established between the first electronic apparatus and the second electronic apparatus, which will not be described herein in detail.

In this embodiment, the displaying the scanned at least one wireless access includes:

displaying parameter information of a group corresponding to the scanned at least one wireless access node.

Specifically, the second electronic apparatus may display the wireless access node in the form of a group after a wireless access node named by parameter information of a group of the first application is scanned by the second electronic apparatus. For example, in the case where the scanned wireless access node is named “First Board”, the scanned wireless access node is displayed on the second electronic apparatus as a group named “First Board” because the name of a wireless access node is named according to parameter information in the case where the first electronic apparatus establishes a group. Thus, after the group named “First Board” is selected on the second electronic apparatus by a user, the second electronic apparatus can establish a communication channel with the first electronic apparatus which establishes the wireless access node, and join the group named “First Board”.

In this embodiment, after the joining the first group through the communication channel, the method further includes:

in the case where the first application stops running, breaking the communication channel and controlling the second wireless communication module to stop receiving the radiation signal.

The second embodiment has the same effect as that of the first embodiment in the terms of breaking the communication channel in the case where the first application stops running. In the case where the first application stops running, the communication channel is broken and the second wireless communication module is controlled to stop receiving the radiation signal, this can avoid that other electronic apparatuss acquires information stored on the second electronic apparatus through the communication channel, and achieve a technical effect of improving safety of the information stored on the second electronic apparatus.

Hereinafter, viewed from a perspective of human-computer interaction, an explanation is carried out by taking that the second electronic apparatus is a tablet computer and the first application is a board game installed on the smartphone as an example.

For example, in the case where user B wants to play a board game, user B turns on an application of the board game on the tablet computer and performs a touch click on a displaying interface of the application to select “no extranet mode”, then two options of “join a group” and “establish a new group” are displayed on the tablet computer.

After user B performs a touch click on the option of “establish a new group”, the smartphone controls, in response to a selection operation, a wireless communication module in the smartphone to turn on its function of sending and receiving signal so as to receive a radiation signal sent by a wireless access node.

After wireless access nodes named “First Board” and “Second Board” established by establishing a group of a board game for users A and C respectively are scanned through a wireless communication module on the tablet computer of user B, groups named “First Board” and “Second Board” are displayed on the board application interface of the tablet computer of user B.

User B sends, after touching to select the group named “First Board”, a connection request to the smartphone of user A.

The smartphone of user A establishes, after receiving the connection request, in a radio link layer, a direct communication channel with the tablet computer of user B. Through the communication channel, the tablet computer of the user B joins the first group named “First Board”.

User B and user A can play a board game in the first group through network.

### Third Embodiment

According to this embodiment, it is provided another method for processing information, to achieve a technical effect that: in the case of no external network, an electronic apparatus can automatically start an application corresponding to a display identifier for the wireless access node when establishing connection with a wireless access node obtained by scanning, so as to conveniently perform data interaction for the application, thereby reducing operational complexity.

According to this embodiment, it is provided a method for processing information applied to a second electronic apparatus, the second electronic apparatus includes a wireless communication module and a display module, the second electronic apparatus is able to acquire a first application and N general applications, N≧1; and in the case that the second electronic apparatus has the first application and the wireless communication module is in a working state, the method includes:

acquiring and displaying a first control in the case where the first application runs;

receiving a first triggering operation for the first control and controlling, in response to a first triggering operation for the first control, the wireless communication module to perform scan, and acquire K wireless access nodes, where the K wireless access nodes are in one-to-one correspondence with K display identifiers, K≧1;

displaying the K display identifiers by the display module;

acquiring a first controlling operation for selecting a first display identifier from the K display identifiers; and

establishing, in response to the first controlling operation, a direct communication channel with a first wireless access node corresponding to the first display identifier in a radio link layer, and starting, based on the first display identifier, a first general application corresponding to the first display identifier from the N general applications to enable the first general application to run.

It may be seen from the above content that: in the case where the first application runs, K display identifiers corresponding to the K wireless access nodes acquired by scanning are displayed; and in the case where a user selects the first display identifier, the communication channel with the first wireless access node corresponding to the first display identifier is established and the first general application corresponding to the first display identifier is started, so as to achieve a technical effect that in the case of no external network, the electronic apparatus can automatically start the application corresponding to the display identifier for the wireless access node when establishing connection with the wireless access node acquired by scanning, thereby reducing operational complexity.

In order to better understand the technical solutions described above, the technical solutions described above will be illustrated in detail in combination with the accompanying drawings of the specification and the specific implementing ways hereinafter.

According to this embodiment, it is provided a method for processing information applied to a second electronic apparatus. The first electronic apparatus includes a wireless communication module and a display module, the second electronic apparatus can acquire a first application and N general applications, N≧1. The second electronic apparatus may be a smart phone, a notebook computer, a tablet, a desktop computer and so on, which is not listed in detail in the embodiment.

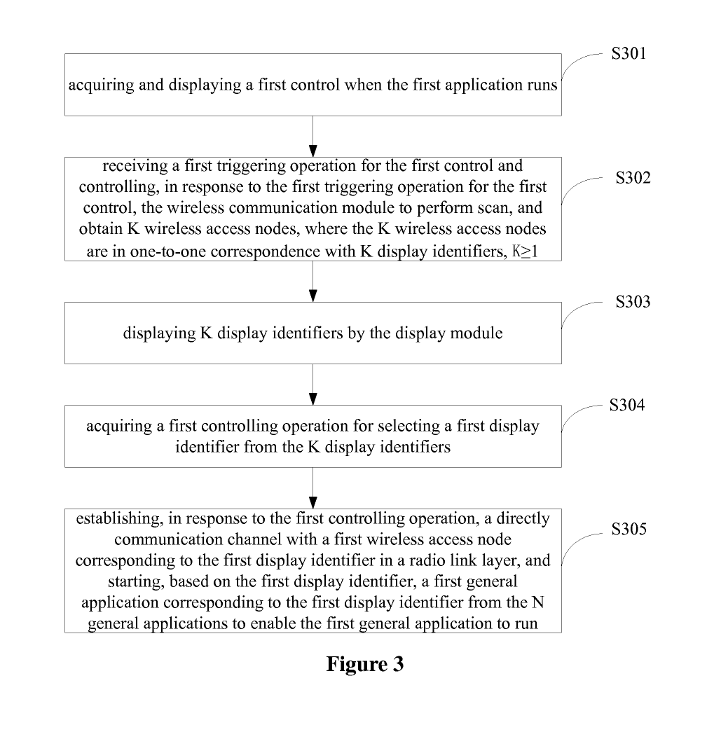

Reference is made to FIG. 3, which is a flow chart of a method for processing information according to the this embodiment of the disclosure. In the case that the second electronic apparatus has the first application and the wireless communication module is in a working state, the method includes step S301 to step S305.

In step S301, acquiring and displaying a first control when the first application runs.

In step S302, receiving a first triggering operation for the first control and controlling, in response to the first triggering operation for the first control, the wireless communication module to perform scan, and obtain K wireless access nodes, where the K wireless access nodes are in one-to-one correspondence with K display identifiers, K≧1.

In step S303, displaying K display identifiers by the display module.

In step S304, acquiring a first controlling operation for selecting a first display identifier from the K display identifiers.

In step S305, establishing, in response to the first controlling operation, a directly communication channel with a first wireless access node corresponding to the first display identifier in a radio link layer, and starting, based on the first display identifier, a first general application corresponding to the first display identifier from the N general applications to enable the first general application to run.

In practice, the wireless access node may be a wireless access node established by a wireless communication module within an electronic apparatus such as a smart phone, a notebook computer, a tablet, a desktop computer, which is not listed in detail in the embodiment.

In the specific implementation process, the first application may be used for data transmission and establishing network connection. The N general applications may be game applications. The user may call other game applications by the first application for playing.

Firstly, in step S301, a first control is acquired and displayed in the case where the first application runs.

In the specific implementation process, the first control is set in the first application in advance. In the case where the first application runs, the first control may be displayed in an application interface for the first application in the form of a touch button or a touch icon.

After the first control is displayed in step S301, step S302 is performed, i.e., receiving a first triggering operation for the first control and controlling, in response to the first triggering operation for the first control, the wireless communication module to perform scan, and acquiring K wireless access nodes, where the K wireless access nodes are in one-to-one correspondence with K display identifiers, K≧1.

In the embodiment of the disclosure, the wireless access node may be a WIFI hotspot. By setting the wireless access node as a WIFI hotspot, more than two electronic apparatuss can simultaneously establish connection with the wireless access node.

A case that how the second electronic apparatus find a wireless access node by scanning without external network coverage will be illustrated in detail hereinafter.

In the case that the first electronic apparatus is not in the converge range of external network, a wireless communication module in the first electronic apparatus still has functions for sending and receiving a signal due to its hardware structure. In the case where the first application runs, the first application controls the wireless communication module in the second electronic apparatus to start the functions for sending and receiving a signal, and the wireless communication module constantly receives a radiation signal sent from wireless access nodes within a certain range. At this point, if there is a first electronic apparatus located within the range of the signal received by the second electronic apparatus and a second wireless communication module of the first electronic apparatus is set as a second wireless access point, as well as the second wireless communication module also starts functions for sending and receiving a signal and sends a radiation signal, the second electronic apparatus scans the second wireless access point established by the first electronic apparatus in the case where the wireless communication module in the second electronic apparatus receives the radiation signal.

In the embodiment of the disclosure, in order to solve a problem that too many wireless access nodes are scanned to acquired by the wireless communication module hence it is not convenient to select for a user, the performing scan and acquiring K wireless access nodes by the wireless communication module may be implemented according to the following ways.

The wireless communication module performs scan and acquires M wireless access nodes, M≧k.

The second electronic apparatus performs filtering based on M display identifiers in one-to-one correspondence with the M wireless access nodes to acquire K wireless access nodes conforming to a first preset condition from the M wireless access nodes.

In regard to how to set the first preset condition, it will be illustrated in detail based on two cases hereinafter: one case is that the second electronic apparatus is not connected with a server, and the other case is that the second electronic apparatus is connected a server.

In the case where the second electronic apparatus is not connected with a server, the first preset condition may be that, a display identifier corresponding to the wireless access node is a display identifier corresponding to the general application possessed by the first electronic apparatus.

That is to say, K wireless access nodes the display identifiers of which are display identifiers corresponding to the general applications possessed by the second electronic apparatus are filtered from M wireless access nodes.

In the specific implementing process, each wireless access node which is acquired by scanning of the second electronic apparatus has a display identifier. The display identifier may be a name for a wireless access node and is generated according to parameter information of the general application for controlling the establishment of the wireless access node.

For example, in the case that a second wireless access node is established by a first electronic apparatus under the control of a second general application, the second wireless access node is named by parameter information of the second general application and the name of the second wireless access node is used as the second display identifier, such that in the case where the second electronic apparatus scans the second wireless access node, the second electronic apparatus can identify the second general application according to the second display identifier for the second wireless access node. If the second electronic apparatus has the second general application, the second wireless access node is selected as one of the K wireless access nodes.

Furthermore, the performing filtering to acquire K wireless access nodes may include:

acquiring M display identifiers in one-to-one correspondence with M wireless access nodes;

performing filtering to acquire K display identifiers corresponding to the parameter information of the general application possessed by the second electronic apparatus from the M display identifiers; and

acquiring K wireless access nodes corresponding to the K display identifiers.

Specifically, only in the case that a display identifier corresponding to the wireless access node is a display identifier corresponding to the general application possessed by the second electronic apparatus, the wireless access node is displayed, such that the general application corresponding to the displayed display identifier can be directly started on the second electronic apparatus without installing the general application.

In the case where the second electronic apparatus is connected with a server, the first preset condition is that, a display identifier corresponding to the wireless access node is a display identifier corresponding to general applications within a first preset list, where the general applications in the first preset list are stored in the server.

That is to say, there are a large number of general applications stored in the server connected with the second electronic apparatus in advance, and K wireless access nodes the display identifiers of which are display identifiers corresponding to parameter information for the general applications stored in the server need to be selected from the M wireless access nodes.

For example, a general application named “Fight the Landlord” is stored in the server. In the case that the display identifier for the first wireless access node from the M wireless access nodes is “Fight the Landlord 1”, the display identifier for the first wireless access node is considered as the display identifier corresponding to the general application named “Fight the Landlord”, hence the first wireless access node is selected as one of the K wireless access nodes.

Furthermore, the performing filtering to acquire K wireless access nodes may include:

acquiring M display identifiers in one-to-one correspondence with the M wireless access nodes;

performing filtering to acquire K display identifiers corresponding to the parameter information for the general application stored in the server from the M display identifiers; and

acquiring K wireless access nodes corresponding to the K display identifiers.

Specifically, in the case that the second electronic apparatus is connected with the server, only in the case that a display identifier corresponding to the wireless access node is the display identifier corresponding to the general application stored in the server, the wireless access node is displayed, such that all the installation files for the applications corresponding to the displayed display identifiers can be acquired from the server.

As a matter of course, the first preset condition for performing filtering to acquire the K wireless access nodes may not only be the two fixed conditions described above, but also be flexibly set in advance according to the requirement in the first application possessed by the second electronic apparatus by the user.

In addition to the above two methods for setting the first preset condition, a third and a fourth scheme for setting the first preset condition are provided in the embodiments of the present disclosure.

It is considered that the first general application may be a game application, while the game application generally has default limit for the number of players. For example, 3 players are be allowed to participate in the game of “Fight the Landlord” by default.

The first preset condition may be that, a first connection number for electronic apparatuss connected to the wireless access node is less than a maximum connection number for the general application corresponding to the wireless access node by default.

For example, there is a wireless access node named “Fight the Landlord” from the M wireless access nodes scanned by the second electronic apparatus, while the general application corresponding to “Fight the Landlord” limits the number of players as 3 by default; in addition to a first electronic apparatus establishing the wireless access node named by “Fight the Landlord”, 2 electronic apparatuss are also allowed to participate in the general application of “Fight the Landlord”, hence the maximum connection number for the general application of “Fight the Landlord” is 2.

If 2 electronic apparatuss have been connected to the wireless access node named by “Fight the Landlord”, which indicates that the number of the participants of the general application of “Fight the Landlord” reaches its maximum connection number, the second electronic apparatus does not display the wireless access node named by “Fight the Landlord”.

The second electronic apparatus may acquire the first connection number by the following way. Each time one electronic apparatus is connected to the first wireless access node established by the first electronic apparatus, a counter within the first electronic apparatus adds 1, and the first connection number for the connected electronic apparatuss is added to a first display identifier for the first wireless access node, such that the second electronic apparatus may acquire the first connection number according to the scanned first display identifier.

The first electronic apparatus may acquire the maximum connection number by the following way. In the case where the first electronic apparatus establishes the first wireless access node, the default maximum connection number for the corresponding general application is added to the first display identifier for the first wireless access node, such that the second electronic apparatus may acquire the maximum connection number according to the scanned first display identifier.

Furthermore, the first preset condition may be that, the display identifier corresponding to the wireless access node includes a first label, where the first label is used to indicate that the wireless access node is a wireless access node established by the first application.

Specifically, the second electronic apparatus is set to only display the wireless access node the display identifier of which includes the first label, such that all of the displayed wireless access nodes are the wireless access nodes established according to the first application by other electronic apparatuss, which avoids displaying a large number of unavailable wireless access nodes, hence it is convenient for quickly selecting the wireless access node suitable for connecting with the first application by the user.

After K wireless access nodes are acquired in step S302, the method proceeds to step S303, the K display identifiers are displayed by the display module.

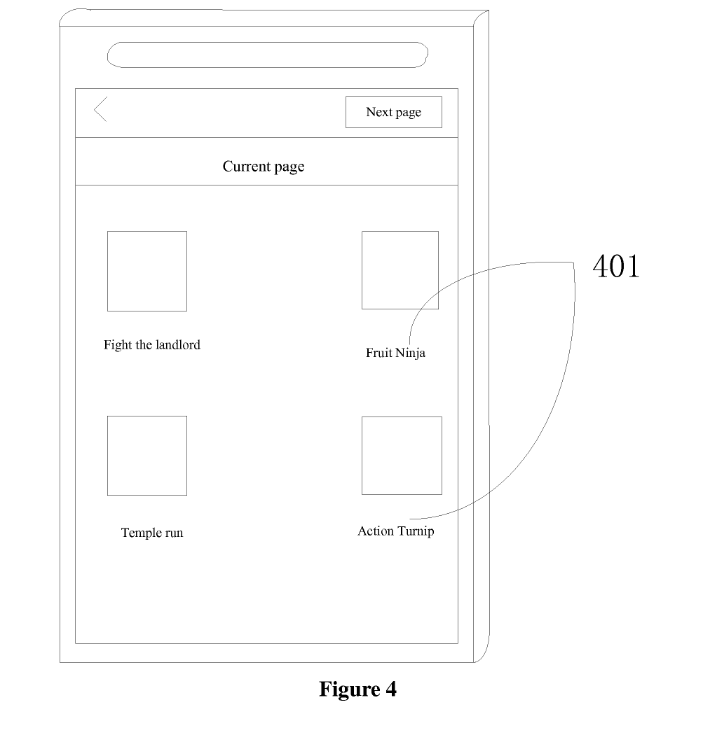

Reference is made to FIG. 4 which is a schematic diagram for displaying a display identifier according to the third embodiment of the disclosure. As shown in FIG. 4, K display identifiers 401 correspond to names of k general applications.

For example, the name of one of the K wireless access nodes is “Fight the Landlord”, the wireless access node is displayed as a string of “Fight the Landlord” on the display module of the second electronic apparatus.

In the specific implementing process, in addition to displaying the name of the corresponding general application, the display identifier may also display the first connection number for electronic apparatuss connected to the corresponding wireless access node presently.

For example, in the case that the name of one of the K wireless access nodes is “Fight the Landlord” and two players have connected to the wireless access node named by “Fight the Landlord”, a number 2 is displayed on the display identifier corresponding to the wireless access node named by “Fight the Landlord”, which indicates that 2 devices have been connected to the wireless access nodes named by “Fight the Landlord”.

The second electronic apparatus may acquire the first connection number by the following way. Each time one electronic apparatus is connected to the first wireless access node established by the first electronic apparatus, a counter within the first electronic apparatus adds 1, and the number for the connected electronic apparatuss is added to a first display identifier for the first wireless access node, such that the second electronic apparatus may acquire the first connection number according to the scanned first display identifier.

Next, the method proceeds to step S304, a first controlling operation for selecting a first display identifier is acquired from the K display identifiers.

In the specific implementing process, the first controlling operation may be an operation for an interface made on a selection interface of a wireless access node which runs the first application, such as a touch clicking operation, a mouse clicking operation, may also be a preset gesture operation or a shaking operation for the second electronic apparatus, which is not listed in detail in the embodiment.

Next, the method proceeds to step S305, i.e., establishing, in response to the first controlling operation, a direct communicating channel with the first wireless access node corresponding to the first display identifier in a radio link layer, and starting, based on the first display identifier, a first general application corresponding to the first display identifier from the N general applications to enable the first general application to run.

In the specific implementing process, in the case that the second electronic apparatus has the first general application, the second electronic apparatus may directly call a starting program for the first general application in the second electronic apparatus after the second electronic apparatus identifies the first general application according to the first display identifier, so as to start the first general application.

In case where the first electronic apparatus is connected with the server, the starting, based on the first display identifier, a first general application corresponding to the first display identifier from the N general applications may include:

generating a first acquiring request and sending the first acquiring request and the first display identifier to the server;

receiving a first installation file which is returned based on the first acquiring request by the server and used to install the first general application corresponding to the first display identifier; and

installing and starting the first general application based on the first installation file.

After the first general application runs in step S305, the method further includes:

performing data exchange corresponding to the first general application with the first electronic apparatus via the communication channel, where the first electronic establishes the first wireless access node.

That is to say, the second electronic apparatus interacts data for the first general application with the first electronic apparatus via the communication channel established in step S105, where the first electronic apparatus on which the first general application runs, establishes the first wireless access node, and generates the first display identifier for the first wireless access node according to parameter information for the first general application.

In the embodiment of the disclosure, after performing data exchange corresponding to the first general application with the first electronic apparatus via the communication channel, the method further includes:

performing data exchange with the first electronic apparatus via the communication channel, so as to enter a same group for the first general application with the first electronic apparatus to perform tasks together.

In the specific implementing process, in addition to scanning wireless access nodes around by selecting a first control on a display interface for the first application, wireless access nodes may also be established by selecting a second control on the display interface for the first application, such that other electronic apparatuss around can scan the established wireless access nodes. As a matter of course, selecting the first control or the second control may be determined according to the user's requirement, the first control and the second control have no particular order.

Specifically, a specific process that wireless access nodes are established by selecting the second control on the display interface for the first application may be:

entering a local general application list after the second control is selected. A user establishes a second wireless access node after selecting a second general application in the local general application list, and uses the name of the second general application as a display identifier for the second wireless access node.

In the following, assuming that the second electronic apparatus is a smart phone, the first electronic apparatus is a tablet, the first general application is a game of “Fight the Landlord”, the solutions provided in the embodiment will be illustrated in detail from a point of view of human-computer interaction.

Firstly, user A starts a first application on the smart phone, and clicks a first control displayed as an icon of “I want to play a game” on an interface for a first application; the smart phone controls an internal wireless communication module to perform scan and acquire M wireless access nodes in response to the clicking operation, and displays names of the M wireless access nodes on the interface for the first application.

Next, user A selects a first wireless access node named by “Fight the Landlord” from the M wireless access nodes, the smart phone establishes communication connection with the first wireless access node in response to the selecting operation of the user, and starts the first general application named by “Fight the Landlord” on the smart phone.

After the first general application is started, user A and user B which uses a tablet computer establishing the first wireless access node participate in a same game group of “Fight the Landlord” together via the communication connection, and may play the game of “Fight the Landlord” together in the same game group.

As a matter of course, if there is no game of “Fight the Landlord” which user A wants to play from the M wireless access nodes displayed on the interface for the first application, or user A wants to establish a new game, user A may enter a local game list interface for the application program, establish a wireless access node identified by a display identifier of “Fight the Landlord” by selecting the game of “Fight the Landlord” in the local game list interface, such that other electronic apparatuss around may play the game of “Fight the Landlord” with user A together by selecting the wireless access node identified by the display identifier of “Fight the Landlord”.

In another aspect, based on the same conception, another method is provided in the present disclosure for starting a first general application from the N general applications based on the first display identifier according to another embodiment of the disclosure, which is referred to a fourth embodiment.

### Fourth Embodiment

In the fourth embodiment, there is provided a method for processing information applied to a second electronic apparatus. The second electronic apparatus includes a wireless communication module and a display module. The second electronic apparatus can acquire a first application and N general applications, N≧1. The second electronic apparatus may be a smart phone, a notebook computer, a tablet, a desktop computer and so on, which is not listed in detail in the embodiment.

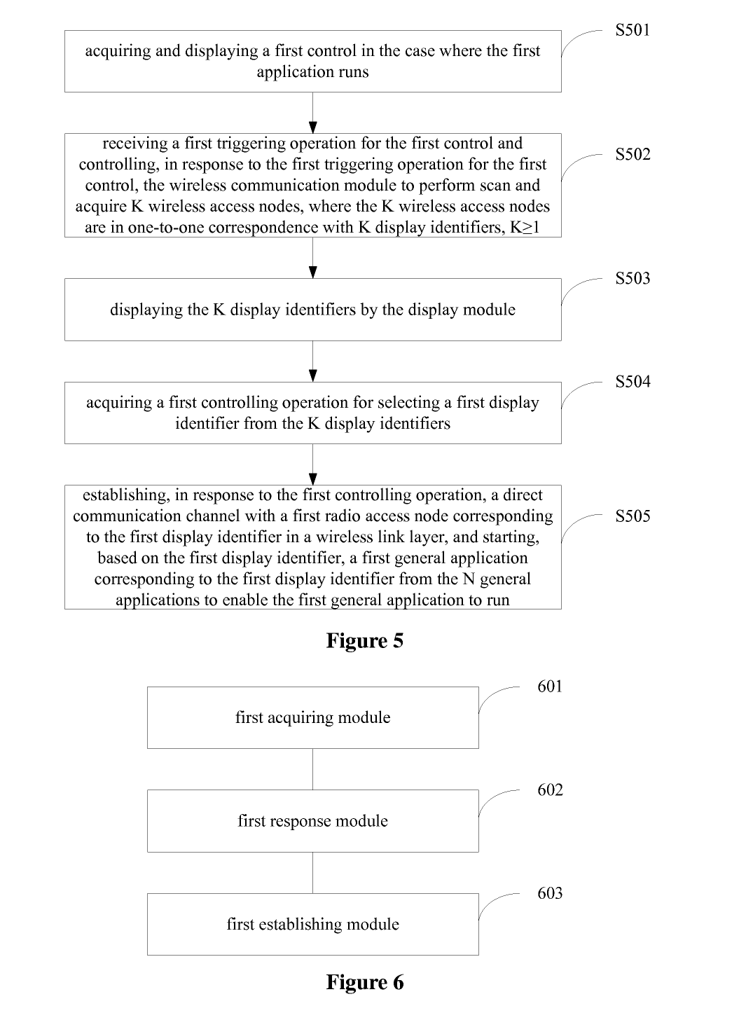

Being the same as the third embodiment, as shown in FIG. 5, in the case that the first electronic apparatus has the first application and the wireless communication module is in a working state, the method includes step S301-S505.

In step S501, acquiring and displaying a first control in the case where the first application runs.

In step S502, receiving a first triggering operation for the first control and controlling, in response to the first triggering operation for the first control, the wireless communication module to perform scan and acquire K wireless access nodes, where the K wireless access nodes are in one-to-one correspondence with K display identifiers, K≧1.

In step S503, displaying the K display identifiers by the display module.

In step S504, acquiring a first controlling operation for selecting a first display identifier from the K display identifiers.

In step S505, establishing, in response to the first controlling operation, a direct communication channel with a first wireless access node corresponding to the first display identifier in a radio link layer, and starting, based on the first display identifier, a first general application corresponding to the first display identifier from the N general applications to enable the first general application to run.

In this embodiment, in the case that the second electronic apparatus does not have the first general application corresponding to the first display identifier, the starting, based on the first display identifier, a first general application from the N general applications may include:

generating a second acquiring request and sending the second acquiring request and the first display identifier to a first wireless access node corresponding to the first display identifier;

receiving, via the communication channel, a first installation file which is returned based on the second acquiring request by the first wireless access node and used to install a first general application corresponding to the first display identifier; and

installing and starting the first general application based on the first installation file.

Specifically, after the communication channel is established in step S105, even if in the case that the second electronic apparatus does not have the first general application corresponding to the first display identifier and the second electronic apparatus is not connected with a server, the second electronic apparatus may also acquire the first installation file for the first general application corresponding to the first display identifier from the first wireless access node via the communication channel between the second electronic apparatus and the first wireless access node, so as to install and start the first general application.

After the first general application is started, the second electronic apparatus can interact data for the first general application with a first electronic apparatus via the communication channel established in step S505, where the first electronic apparatus on which the first general application runs, establishes the first wireless access node, and generates the first display identifier for the first wireless access node according to parameter information for the first general application.

In the following, assuming that the second electronic apparatus is a smart phone, the first electronic apparatus is a tablet, the first general application is a game of “Fight the Landlord”, the solutions provided in the embodiment will be illustrated in detail from a point of view of human-computer interaction.

Firstly, user A starts a first application on the smart phone, and clicks a first control displayed as an icon of “I want to play a game” on an interface for the first application; the smart phone controls an internal wireless communication module to perform scan to acquire M wireless access nodes in response to the clicking operation, and displays names of the M wireless access nodes on the interface for the first application.

Next, user A selects a first wireless access node named by “Fight the Landlord” from the M wireless access nodes, the smart phone establishes communication connection with the first wireless access node in response to the user's selection operation, and sends the second acquiring request and the display identifier for “Fight the Landlord” to a tablet computer establishing the first wireless access node.

After receiving the second acquiring request, the tablet computer returns an installation file package for the general application of “Fight the Landlord” to the smart phone via the communication connection.

After the general application of “Fight the Landlord” is started, user A and user B who uses a tablet computer establishing the first wireless access node participate in a same game group of “Fight the Landlord” together via the communication connection, and may play the game of “Fight the Landlord” together in the same game group.

### Fifth Embodiment

In the fifth embodiment, there is provided an electronic apparatus which is a first electronic apparatus that includes a first wireless communication module and is able to acquire a first application. The first electronic apparatus may be an electronic apparatus such as a smartphone, laptop, a tablet computer, or a desktop computer, which will not be enumerated fully in this embodiment.

Referring to FIG. 6, which is a schematic structural diagram of an electronic apparatus according to the fifth embodiment of the disclosure. In the case where the first electronic apparatus has the first application and the first wireless communication module is in an operating state, the electronic apparatus including:

a first acquiring module 601, configured to acquire, in the case where the first application runs, a first controlling operation for the first application, the first controlling operation being used to instruct to establish a first group capable of including at least two participants;

a first response module 602, configured to, establish the first group in response to the first controlling operation, control the first wireless communication module to serve as a wireless access node, and naming the wireless access node by parameter information of the first group, with the wireless access node generating a radiation signal such that, in the case where at least one second electronic apparatus is in the coverage area of the radiation signal, the wireless access node is able to be scanned by the at least one second electronic apparatus; and

a first establishing module 603, configured to establish, in a radio link layer, a direct communication channel with the at least one second electronic apparatus after response information is acquired, the response information being generated by the at least one second electronic apparatus in the coverage area of the wireless access node when the wireless access node is scanned and selected by the at least one second electronic apparatus; and add, through the communication channel, the at least one second electronic apparatus to the first group.

In this embodiment, the wireless access node is a WIFI hotspot.

In this embodiment, the electronic apparatus further includes:

a first breaking module, configured to, in the case where the first application stops running, break the communication channel and control the first wireless communication module to stop serving as the wireless access node.

The electronic apparatus provided in this embodiment and the method for processing information provided in the first embodiment are two aspects based on the same inventive concept, and the implementation process of the method has been described previously in detail, thus those skilled in the art may understand clearly, according to the previous description, a structure and an implementation process of the electronic apparatus in this embodiment, which will not be described in detail for brevity of the specification.

In another aspect, based on the same inventive concept, the disclosure provides, by another embodiment, an electronic apparatus corresponding to the method in the second embodiment, which is explained in detail in the fourth embodiment.

### Sixth Embodiment

In the sixth embodiment, there is provided an electronic apparatus which is a second electronic apparatus that includes a second wireless communication module and is able to acquire a first application. The second electronic apparatus may be an electronic apparatus such as a smartphone, laptop, a tablet computer, or a desktop computer, which will not be enumerated fully in this embodiment.

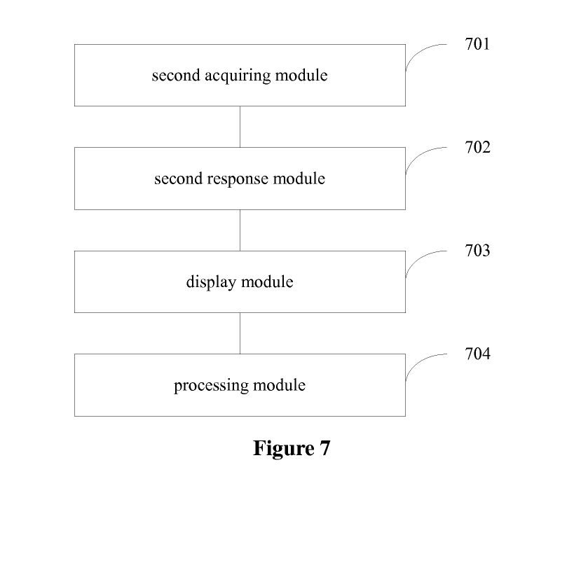

Referring to FIG. 7, which is a schematic structural diagram of an electronic apparatus according to the sixth embodiment of the disclosure. In the case where the second electronic apparatus has the first application and the second wireless communication module is in an operating state, the electronic apparatus including:

a second acquiring module 701, configured to acquire, in the case where the first application runs, a second controlling operation for the first application, the second controlling operation being used to instruct to scan at least one wireless access node named by parameter information of a group of the first application;

a second response module 702, configured to in scanning the at least one wireless access node in response to the second controlling operation, control the second wireless communication module to receive a radiation signal such that, in the case where the second electronic apparatus is in the coverage area of the radiation signal sent by the at least one wireless access node, the at least one wireless access node is able to be scanned by the second electronic apparatus;

a display module 703, configured to display the scanned at least one wireless access node; and

a processing module 704, configured to acquire a selection operation for selecting a first wireless access node from the at least one wireless access node; generate and send, in response to the selection operation, response information to the first wireless access node, so as to establish, in a radio link layer, a direct communication channel with the first electronic apparatus, where the first electronic apparatus establishes the first wireless access node by establishing a first group of the first application; and join the first group through the communication channel.

In this embodiment, the display module 703 is further configured to:

display parameter information of a group corresponding to the scanned at least one wireless access node.

In this embodiment, the electronic apparatus further includes:

a second breaking module, configured to, in the case where the first application stops running, break the communication channel and control the second wireless communication module to stop receiving the radiation signal.

The electronic apparatus provided in this embodiment and the method for processing information provided in the second embodiment are two aspects based on the same inventive concept, and the implementation process of the method has been described previously in detail, thus those skilled in the art may understand clearly, according to the previous description, a structure and an implementation process of the electronic apparatus in this embodiment, which will not be described in detail for brevity of the specification.

The above technical solutions in the embodiments of the disclosure have at least the following technical effects or advantages.

1. In the methods and the electronic apparatuss provided in the embodiments of the disclosure, in the case where the first application runs, by establishing the first group, controlling the first wireless communication module to serve as a wireless access node to generate the radiation signal, and naming the wireless access node by parameter information of the first group, such that the wireless access node is able to be scanned by the second electronic apparatus in the coverage area of the radiation signal, and by establishing, in the case where the second electronic apparatus selects to join the first group, a direct communication channel with the second electronic apparatus, a technical effect is achieved that an electronic apparatus can automatically establish, after entering an application and establishing a group, a connection to an electronic apparatus that selects to join the group without an extranet.

2. In the methods and the electronic apparatuss provided in the embodiments of the disclosure, the wireless access node is as a WIFI hotspot to achieve a technical effect that two or more electronic apparatuss are able to simultaneously join a same group of a same application.

3. In the methods and the electronic apparatuss provided in the embodiments of the disclosure, in the case where the first application stops running, the communication channel is broken and the first wireless communication module is controlled to stop serving as the wireless access node, it can be avoided that other electronic apparatuss continuously acquires information stored on the first electronic apparatus through the communication channel, thus achieving a technical effect of improving safety for the information stored on the first electronic apparatus.

### Seventh Embodiment

According to the seventh embodiment, it is provided another electronic apparatus, which is a second electronic apparatus. The second electronic apparatus includes a wireless communication module and a display module, the first electronic apparatus can acquire a first application and N general applications, N≧1. The first electronic apparatus may be a smart phone, a notebook computer, a tablet, a desktop computer, which is not listed in detail in the embodiment.

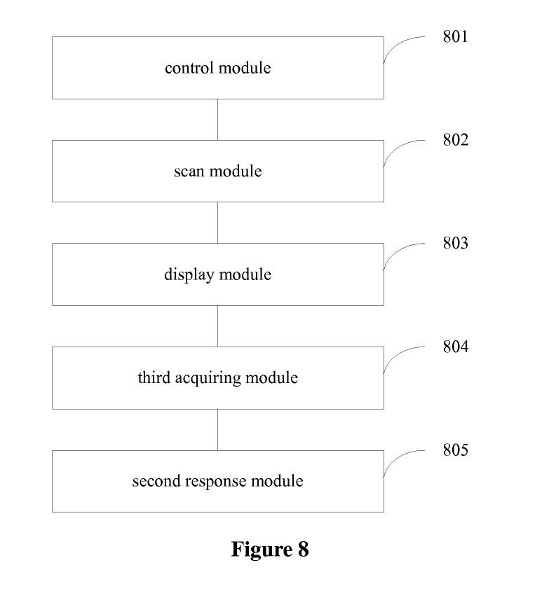

Reference is made to FIG. 8 which is a schematic structural diagram of an electronic apparatus according to the seventh embodiment of the disclosure. In the case that the second electronic apparatus has the first application and the wireless communication module is in a working state, the electronic apparatus includes a control module 801, a scan module 802, a display module 803, a third acquiring module 804 and a second response module 805.

The control module 801 is configured to acquire and display a first control in the case where the first application runs.

The scan module 802 is configured to receive a first triggering operation for the first control and control, in response to the first triggering operation for the first control, the wireless communication module to perform scan to acquire K wireless access nodes, where the K wireless access nodes are in one-to-one correspondence with K display identifiers K≧1.

The display module 803 is configured to display the K display identifiers.

The acquiring module 804 is configured to acquire a first controlling operation for selecting a first display identifier from the K display identifiers.

The response module 805 is configured to establish a direct communication channel with the first wireless access node corresponding to the first display identifier in a radio link layer in response to the first controlling operation, and start a first general application corresponding to the first display identifier from the N general applications based on the first display identifier, so as to enable the first general application to run.

In an embodiment, the scan module 802 includes a wireless communication module and a filtering unit.

The wireless communication module is configured to perform scanning to acquire M wireless access nodes, M≧k.

The filtering unit is configured to perform filtering based on M display identifiers in one-to-one correspondence with the M wireless access nodes, to acquire K wireless access nodes from the M wireless access nodes.

In another embodiment, the filtering unit is further configured to:

perform filtering based on M display identifiers in one-to-one correspondence with the M wireless access nodes, to acquire K wireless access nodes from the M wireless access nodes, where display identifiers corresponding to the K wireless access nodes are display identifiers corresponding to the general applications possessed by the second electronic apparatus.

In an embodiment, in the case that the second electronic apparatus is connected with a server, the filtering unit is further configured to:

perform filtering based on M display identifiers in one-to-one correspondence with the M wireless access nodes to acquire K wireless access nodes from the M wireless access nodes, where display identifiers corresponding to the K wireless access nodes are display identifiers corresponding to general applications in a first preset list, and the general application in the first preset list is a general application stored in the server.

In an embodiment, the response module 705 includes a first sending unit, a first receiving unit and a first start unit.

The first sending unit is configured to generate a first acquiring request and send the first acquiring request and the first display identifier to the server.

The first receiving unit is configured to receive a first installation file which is returned based on the first acquiring request by the server and used to install the first general application corresponding to the first display identifier.

The first start unit is configured to install and start the first general application based on the first installation file.

In an embodiment, in the case that the first electronic apparatus does not have the first general application corresponding to the first display identifier, the response module 305 includes a second sending unit, a second receiving unit and a second start unit.

The second sending unit is configured to generate a second acquiring request and send the second acquiring request and the first display identifier to the first wireless access node corresponding to the first display identifier.

The second receiving unit is configured to receive a first installation file which is returned based on the second acquiring request by the first wireless access node and used to install the first general application corresponding to the first display identifier.

The second start unit is configured to install and start the first general application based on the first installation file.

In an embodiment, the electronic apparatus may also include:

an exchange module, configured to perform data exchange corresponding to the first general application with a first electronic apparatus via the communication channel, where the first electronic apparatus establishes the first wireless access node.

In an embodiment, the exchange module is further configured to:

perform data exchange with the first electronic apparatus via the communication channel, so as to enter a same group for the first general application with the first electronic apparatus.

The electronic apparatus provided in the embodiment and the method for processing information provided in the third embodiment and the fourth embodiment are two aspects based on the same conception. The embodiments of the method have been described in detail above, those skilled in the art may understand the structure of the electronic apparatus and its implementing process in the embodiment according to the above description, which is not described here for conciseness of the specification.

The technical solutions in the embodiments of the disclosure at least have the following technical effects or advantages.

1. According to the method and the electronic apparatus provided in the embodiments of the disclosure, in the case where the first application runs, K display identifiers corresponding to K wireless access nodes acquired by scanning are displayed. And in the case where the user selects the first display identifier, the communication channel with the first wireless access node corresponding to the first display identifier is established and the first general application corresponding to the first display identifier is started, so as to achieve a technical effect that in the case of no external network, the electronic apparatus can automatically start the application corresponding to the display identifier for the wireless access node when establishing connection with the wireless access nodes acquired by scanning, thereby reducing operational complexity.

2. According to the method and the electronic apparatus provided in the embodiments of the disclosure, only in the case that a display identifier corresponding to the wireless access node is a display identifier corresponding to the general application possessed by the second electronic apparatus, the wireless access node is displayed, so as to achieve a technical effect that the application corresponding to the displayed display identifier is directly started on the second electronic apparatus without installation, thereby reducing operational complexity.

3. According to the method and the electronic apparatus provided in the embodiments of the disclosure, in the case that the second electronic apparatus is connected with the server, the wireless access node is displayed only in the case that a display identifier corresponding to the wireless access node is a display identifier corresponding to the general application stored in the server, so as to achieve a technical effect that all the installation files corresponding to the displayed display identifiers can be acquired from the server.

Those skilled in the art should understand that the embodiment of the disclosure can be embodied as methods, systems, or computer program products. Accordingly, the disclosure can adopt the forms of a pure hardware embodiment, a pure software embodiment, or a combination of software and hardware. Moreover, the disclosure can adopt a form of a computer program product which is implemented on one or more computer usable storage media (including but not limited to a disk storage, CD-ROM, an optical memory and the like) containing the computer usable program code.

The disclosure is described with reference to the method, apparatus (system), and the flowchart and/or block diagram of a computer program product according to the embodiments of the disclosure. It should be understood that each flowchart and/or block diagram of the flowcharts and/or block diagrams or a combination thereof can be achieved by computer program instructions. These computer program instructions can be supplied to a general purpose computer, a special purpose computer, an embedded processor or other programmable data processing apparatus to produce a machine, so that a device for implementing one or more flows in the flowcharts and/or functions specified in one or more of the block diagrams can be produced by means of the instructions executed by the computer or other programmable data processing apparatus.

These computer program instructions can also be stored in a computer-readable memory that can direct a computer or other programmable data processing apparatus to work in a specific manner, so that the instructions stored in the computer readable memory generates manufactured articles including the instruction device which implements one or more flows in the flowcharts and/or the functions specified in one or more of the block diagrams.

These computer program instructions can also be loaded to a computer or other programmable data processing apparatus, so that a series of operation steps are executed on the computer or other programmable apparatus to produce the computer-implemented processing, thus enabling the instructions executed on the computer or other programmable apparatus to provide steps for implementing one or more flows in the flowchart and/or functions specified by one or more of the block diagrams.

Specifically, computer program instructions corresponding to the two kinds of method for processing information in the embodiments of the disclosure may be stored on a storage medium such as an optical disk, a hard disk, a USB flash disk or the like.

For the method for processing information provided in the first embodiment, in the case where computer program instructions corresponding to the method for processing information in a storage medium is read or executed by an electronic apparatus, the following steps are included:

acquiring, in the case where the first application runs, a first controlling operation for the first application, the first controlling operation being used to instruct to establish a first group capable of including at least two participants;

establishing the first group in response to the first controlling operation, controlling the first wireless communication module to serve as a wireless access node, and naming the wireless access node by parameter information of the first group, with the wireless access node generating a radiation signal such that, in the case where at least one second electronic apparatus is in the coverage area of the radiation signal, the wireless access node is able to be scanned by the at least one second electronic apparatus;

establishing, in a radio link layer, a direct communication channel with the at least one second electronic apparatus after response information is acquired, the response information being response information generated by the at least one second electronic apparatus in the coverage area of the wireless access node in the case where the wireless access node is scanned and selected by the at least one second electronic apparatus; and

adding, through the direct communication channel, the at least one second electronic apparatus to the first group.

Optionally, in the process of executing computer instructions stored in the storage medium corresponding to the step of controlling the first wireless communication module to serve as a wireless access node, and naming the wireless access node by parameter information of the first group, with the wireless access node generating a radiation signal, and specifically, the following step is included:

controlling the first wireless communication module to be a WIFI hotspot, and naming the WIFI hotspot by the parameter information of the first group, with the WIFI hotspot generating a radiation signal.

Optionally, additional computer instructions are also stored in the storage medium, these additional computer instructions are executed after executing computer instructions corresponding to the step of adding, through the direct communication channel, the at least one second electronic apparatus to the first group, and in the case where the additional computer instructions are executed, the following step is included:

in the case where the first application stops running, breaking the direct communication channel and controlling the first wireless communication module to stop serving as the wireless access node.

For the method for processing information provided in the second embodiment, in the case where computer program instructions corresponding to the method for processing information in a storage medium is read or executed by an electronic apparatus, the following steps are included:

acquiring, in the case where a first application runs, a second controlling operation for the first application, wherein the second controlling operation instructs to scan at least one wireless access node;

controlling the second wireless communication module to receive at least one radiation signal from the at least one wireless access node;

displaying the at least one wireless access node;

selecting a first wireless access node from the at least one wireless access node, generating and sending response information to the first wireless access node, to facilitate a first electronic apparatus serving as the first wireless access node establishing a direct communication channel between the first electronic apparatus and the second electronic apparatus; and

joining a first group established by the first electronic apparatus through the direct communication channel.

In the process of executing computer instructions stored in the storage medium corresponding to the step of displaying the scanned at least one wireless access node, and specifically, the following step is included:

displaying at least one of identifier corresponding to the at least one wireless access node by a display module.

Optionally, additional computer instructions are also stored in the storage medium, these additional computer instructions are executed after executing computer instructions corresponding to the step of joining the first group through the direct communication channel, and in the case where the additional computer instructions are executed, the following step is included:

in the case where the first application stops running, breaking the direct communication channel and controlling the second wireless communication module to stop receiving the radiation signal.

For the method for processing information provided by the third embodiment, in the case where computer program instructions in the storage medium corresponding to the method for processing information are read or executed by one electronic apparatus, the method includes the following steps:

acquiring and displaying a first control in the case where a first application runs;

receiving a first triggering operation for the first control and controlling, in response to the first triggering operation for the first control, the wireless communication module to perform, and acquire K wireless access nodes, where the K wireless access nodes are in one-to-one correspondence with K display identifiers, K≧1;

displaying K display identifiers by the display module;

acquiring a first controlling operation for selecting a first display identifier from the K display identifiers; and

establishing, in response to the first manipulating operation, a direct communication channel with a first wireless access node corresponding to the first display identifiers in a radio link layer, and starting, based on the first display identifier, a first general application corresponding to the first display identifier from the N general applications to enable the first general application to run.

Optionally, executing computer instructions stored in the storage medium corresponding the step that K wireless access nodes are scanned and acquired by the wireless communication module may include:

performing scanning by the wireless communication module to obtain M wireless access nodes, M≧K; and

performing filtering based on M display identifiers in one-to-one correspondence with the M wireless access nodes, to obtain K wireless access nodes conforming to a first preset condition from the M wireless access nodes.

Optionally, executing computer instructions stored in the storage medium corresponding to the step that K wireless access nodes conforming to a first preset condition from the M wireless access nodes are filtered to obtain may include:

performing filtering to obtain K wireless access nodes the display identifiers of which are display identifiers corresponding to the general applications possessed by the first electronic apparatus, from the M wireless access nodes.

Optionally, in the case that the first electronic apparatus is connected with a server, executing computer instructions stored in the storage medium corresponding to the step that K wireless access nodes conforming to the first preset condition from the M wireless access nodes are filtered to obtain may include:

performing filtering to obtain K wireless access nodes the display identifiers of which are display identifiers corresponding to general applications within a first preset list, from the M wireless access nodes, where the general application within the first preset list is a general application stored in the server.

Optionally, executing computer instructions stored in the storage medium corresponding to the step that a first general application corresponding to the first display identifier is started based on the first display identifier from the N general applications may include:

generating a first acquiring request and sending the first acquiring request and the first display identifier to the server;

receiving a first installation file which is returned based on the first acquiring request by the server and used to install the first general application corresponding to the first display identifier; and

installing and starting the first general application based on the first installation file.

Optionally, in the case that the second electronic apparatus does not possess the first general application corresponding to the first display identifier, executing computer instructions stored in the storage medium corresponding to the step that the first general application is started based on the first display identifier from the N general applications may include:

generating a second acquiring request, and sending the second acquiring request and the first display identifier to a first wireless access node corresponding to the first display identifier;

receiving a first installation file which is returned based on the second acquiring request by the first wireless access node and used to install the first general application corresponding to the first display identifier; and

installing and starting the first general application based on the first installation file.

Optionally, the storage medium also stores another computer instructions, theses computer instructions are executed after the computer instructions corresponding to the step that a first general application corresponding to the first display identifier from the N general applications is started so as to enable the first general application to run are executed, executing another computer instructions may include:

performing data exchange corresponding to the first general application with the first electronic apparatus via the communication channel, where the first electronic apparatus establishes the first wireless access node.

Optionally, the storage medium also stores another computer instructions, theses computer instructions are executed after the computer instructions corresponding to the step of performing data exchange corresponding to the first general application with the second electronic apparatus are executed, executing another computer instructions may include:

performing data exchange with the first electronic apparatus via the communication channel, so as to enter a same group for the first general application with the first electronic apparatus.

Although the preferred embodiments of the disclosure have been described, those skilled in the art can make additional variations and modifications to these embodiments once knowing the basic inventive concept of the disclosure. Therefore, the appended claims are intended to be construed as including the preferred embodiments and all changes and modifications that fall within the scope of the disclosure.

Obviously, those skilled in the art can make various modifications and variations to the disclosure without departing from the spirit and scope of the disclosure. Thus, if these modifications and variations of the disclosure belong to the scope defined by the claims of the disclosure and equivalents thereof, the disclosure is also intended to include these modifications and variations.

1. A method for processing information applied to a first electronic apparatus, wherein the first electronic apparatus comprises a first wireless communication module, in the case where the first wireless communication module is in an operating state, the method comprises:
acquiring, in the case where a first application runs, a first controlling operation for the first application, wherein the first controlling operation instructs to establish a first group comprising at least two participants;
controlling the first wireless communication module to serve as a wireless access node generating a radiation signal;
receiving response information from a second electronic apparatus, wherein the second electronic apparatus in a coverage area of the radiation signal, and the response information is generated by the second electronic apparatus in the case where the wireless access node is scanned by the second electronic apparatus;
establishing, in a radio link layer, a direct communication channel with the second electronic apparatus upon reception of the response information; and
adding, through the direct communication channel, the second electronic apparatus to the first group.

2. A method for processing information applied to a second electronic apparatus, wherein the second electronic apparatus comprises a second wireless communication module, in the case where the second wireless communication module is in an operating state, the method comprises:
acquiring, in the case where a first application runs, a second controlling operation for the first application, wherein the second controlling operation instructs to scan at least one wireless access node;
controlling the second wireless communication module to receive at least one radiation signal from the at least one wireless access node;
displaying the at least one wireless access node;
selecting a first wireless access node from the at least one wireless access node, generating and sending response information to the first wireless access node, to facilitate a first electronic apparatus serving as the first wireless access node establishing a direct communication channel between the first electronic apparatus and the second electronic apparatus; and
joining a first group established by the first electronic apparatus through the direct communication channel.

3. The method according to claim 2, wherein the displaying the at least one wireless access node comprises:
displaying at least one of identifier corresponding to the at least one wireless access node by a display module.

4. The method according to claim 3, further comprising:
starting a first general application corresponding to a first display identifier based on the first display identifier.

5. The method according to claim 4, wherein selecting a first wireless access node from the at least one wireless access node comprises:
acquiring M wireless access nodes by the second wireless communication module performing scan; and
selecting K first wireless access nodes confirming to a first preset condition from the M wireless access nodes, wherein M≧K.

6. The method according to claim 5, wherein the first preset condition comprises:
a display identifier corresponding to the first wireless access node is a display identifier corresponding to a general application installed on the second electronic apparatus.

7. The method according to claim 5, wherein in the case where the second electronic apparatus is connected with a server, the first preset condition comprises:
a display identifier corresponding to the first wireless access node is a display identifier corresponding to a general application stored in the server.

8. The method according to claim 7, wherein starting a starting a first general application corresponding to a first display identifier based on the first display identifier comprises:
generating a first acquiring request, sending the first acquiring request and the first display identifier to the server;
receiving an installation file of the first general application returned by the server; and
installing and starting the first general application based on the installation file.

9. The method according to claim 4, wherein in the case where the first general application is not installed on the second electronic apparatus, the starting the starting a starting a first general application corresponding to a first display identifier based on the first display identifier comprises:
generating a second acquiring request, sending the second acquiring request and the first display identifier to the first wireless access node corresponding to the first display identifier;
receiving an installation file of the first general application returned by the first wireless access node; and
installing and starting the first general application based on the installation file.

10. An electronic apparatus, comprising a second communication module, a second acquiring module, a second response module, a display module and a processing module, wherein
the second acquiring module is configured to acquire, in the case where a first application runs, a second controlling operation for the first application, wherein the second controlling operation instructs to scan at least one wireless access node;
the second response module is configured to control the second wireless communication module to receive at least one radiation signal from the at least one wireless access node;
the display module is configured to display the at least one wireless access node;
the processing module is configured to select a first wireless access node from the at least one wireless access node, and join a first group established by the first wireless access node.

11. The electronic apparatus according to claim 10, wherein the electronic apparatus displays at least one of identifier corresponding to the at least one wireless access node by the display module;
the second response module is further configured to start a general application corresponding to a first display identifier based on the first display identifier.

12. The electronic apparatus according to claim 11, wherein the second response module comprises:
a wireless communication module, configured to acquire M wireless access nodes by performing scan; and
a filtering unit, configured to select K first wireless access nodes confirming to a first preset condition from the M wireless access nodes, wherein M≧K.

13. The electronic apparatus according to claim 12, wherein the filtering unit further configured to:
select K first wireless access nodes from the M wireless access nodes, based on M display identifier in one-to-one correspondence with the M wireless access nodes, wherein display identifiers corresponding to the K wireless access nodes are display identifiers corresponding to the general applications possessed by the electronic apparatus.

14. The electronic apparatus according to claim 12, wherein in the case the electronic apparatus is connected with a server, the filtering unit is configured to:
select the K first wireless access nodes from the M wireless access nodes, based on the M display identifiers in one-to-one correspondence with the M wireless access nodes, wherein K display identifiers corresponding to the K first wireless access nodes are display identifier corresponding to the general applications stored in by server.

15. The electronic apparatus according to claim 14, wherein the processing module comprises:
a first sending unit, configured to a first acquiring request, send the first acquiring request and the first display identifier to the server;
a first receiving unit, configured to receive an installation file of the first general application return by the server; and
a starting unit, configured to install and start the first general application based on the installation file.

16. The electronic apparatus according to claim 11, wherein in the case where the first general application corresponding to the first display identifier is not installed on the electronic apparatus, the processing module comprises:
a second sending unit, configured to generate a second acquiring request, and send the second acquiring request and the first display identifier to the first wireless access node corresponding to the first display identifier;
a second receiving unit, configured to receive an installation file of the first general application returned by the first wireless access node; and
a second starting unit, configured to install and start the first general application based on the installation file.
